(19) United States
(12) Patent Application Publication
(10) Pub. No.: US 2018/0049401 A1
(43) Pub. Date: Feb. 22, 2018

(54) APPARATUS FOR CONTROLLING LIVESTOCK CONSUMPTION OF A BALED FEED MATERIAL

(71) Applicant: A. LOWELL SLYTER, Aurora, SD (US)

(72) Inventor: A. LOWELL SLYTER, Aurora, SD (US)

(21) Appl. No.: 15/096,370

(22) Filed: Apr. 12, 2016

(51) Int. Cl. A01K 1/10

(52) U.S. Cl. CPC A01K 1/10

(57) ABSTRACT

An apparatus for controlling consumption of a bale of feed material by livestock may include a perimeter member for positioning about a portion of the bale, with the perimeter member defining an opening for at least partially receiving a portion of the bale. The apparatus may include a web mounted on the perimeter member and extending across the opening of the perimeter member. The web may have a periphery connected to the perimeter member, the web including at least one interlinked strand forming a plurality of holes, the at least one strand being flexible, the at least one strand being substantially unstretchable.

### BACKGROUND

### Field

The present disclosure relates to feed control apparatus and more particularly pertains to a new apparatus for controlling livestock consumption of a baled feed material and decreasing wasted feed.

### SUMMARY

The present disclosure relates to an apparatus for controlling consumption of a bale of feed material by livestock. The apparatus may comprise a perimeter member for positioning about a portion of the bale, and the perimeter member may define an opening for at least partially receiving a portion of the bale. The apparatus may also include a web mounted on the perimeter member and extending across the opening of the perimeter member. The web may have a periphery connected to the perimeter member, and may include at least one interlinked strand forming a plurality of holes. The at least one strand may be flexible and may be substantially unstretchable.

There has thus been outlined, rather broadly, some of the more important elements of the disclosure in order that the detailed description thereof that follows may be better understood, and in order that the present contribution to the art may be better appreciated. There are additional elements of the disclosure that will be described hereinafter and which will form the subject matter of the claims appended hereto.

In this respect, before explaining at least one embodiment or implementation in greater detail, it is to be understood that the scope of the disclosure is not limited in its application to the details of construction and to the arrangements of the components set forth in the following description or illustrated in the drawings. The disclosure is capable of other embodiments and implementations and is thus capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

The advantages of the various embodiments of the present disclosure, along with the various features of novelty that characterize the disclosure, are disclosed in the following descriptive matter and accompanying drawings.

### BRIEF DESCRIPTION OF THE DRAWINGS

The disclosure will be better understood and when consideration is given to the drawings and the detailed description which follows. Such description makes reference to the annexed drawings wherein:

FIG. 1 is a schematic side view of a new apparatus for controlling livestock consumption of a baled feed material used with a bale feeder having a portion broken away to reveal details of the apparatus, according to the present disclosure.

FIG. 2 is a schematic top view of the apparatus positioned on a bale, according to an illustrative embodiment.

### DETAILED DESCRIPTION

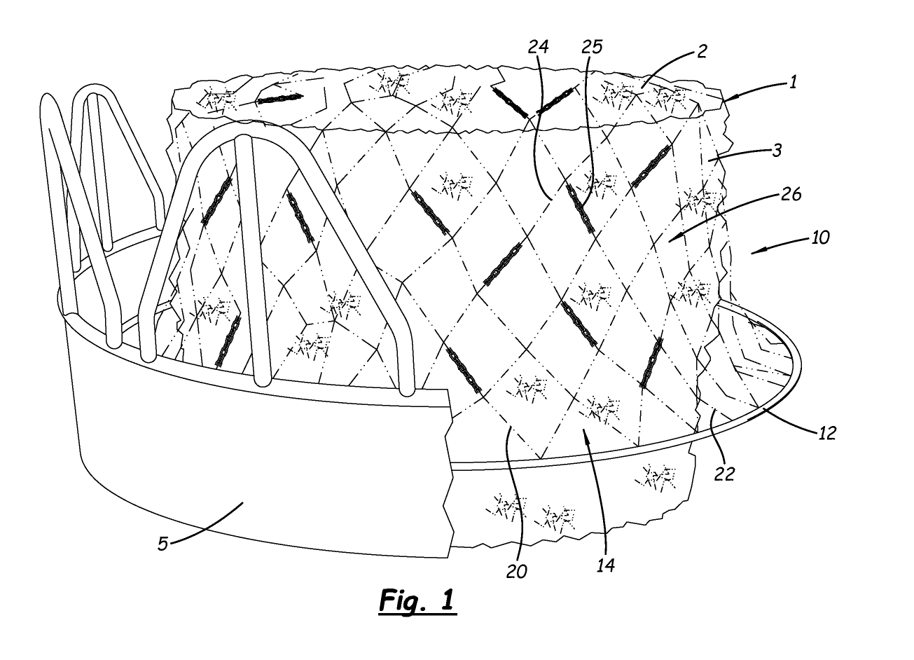

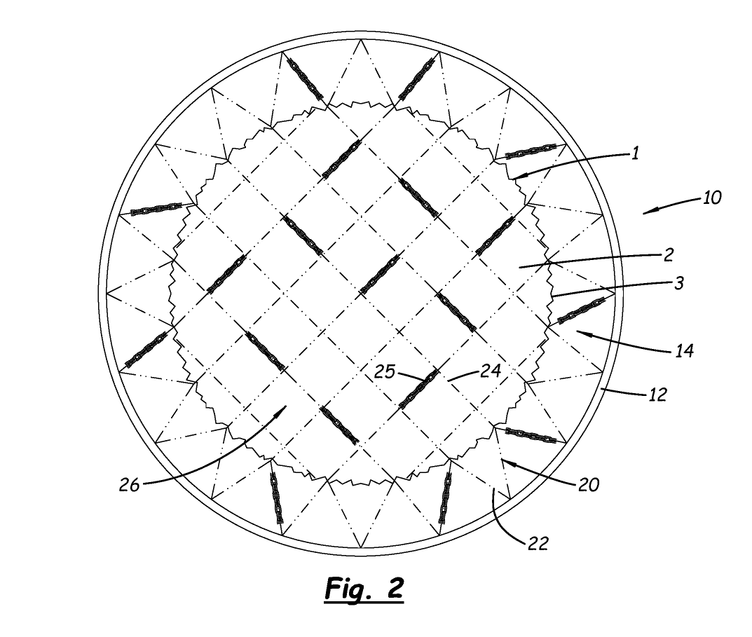

With reference now to the drawings, and in particular to FIGS. 1 and 2 thereof, a new apparatus for controlling livestock consumption of a baled feed material embodying the principles and concepts of the disclosed subject matter will be described.

The applicant has recognized problems associated with feeding livestock from a bale of feed material. One challenge is the ability to control the animal's consumption of the feed material of the bale when the animal has full and unfettered access to a bale of feed. Another problem is the amount of feed that is not consumed, but wasted when the animal is able to bite onto and pull more feed from the bale than it is able to retain in its mouth and chew, and thus the excess feed falls to the ground. Conventional bale feeders are designed to support the bale off of a ground surface, or surround the bale on the ground, in a manner that is generally easily accessible to the livestock, and in some cases may be used to prevent livestock from accessing the bale, but do little to control the animal's access to the bale in a manner that can actually control the animal's rate of consumption of the feed while also decreasing the amount of feed wasted when the animal is able to pull more of the baled material from the bale than can be chewed and consumed.

To address these problems, the applicant has devised an apparatus that allows the animal to feed on the baled material but produces a degree of restriction on the animal's access to the bale to help reduce, for example, the animal's ability to take large bites of the feed material from the bale, and also restrict the animal's ability to pull large clumps of the feed material off of the bale such that significant portions of the feed material falls to the ground before it can be eaten.

The disclosure thus relates to an apparatus 10 for controlling the consumption of a bale 1 of feed material by livestock. The apparatus may be illustratively employed or used with a bale having an upper surface 2 which may be oriented generally horizontally and side surfaces 3 which may extend downwardly from the upper surface and may be generally vertically oriented. For example, a round bale has a cylindrical shape and is typically oriented such that the upper surface is circular and substantially flat, and the side surfaces are substantially cylindrical. The bale may have a height measured from the upper surface 2 down to the lowermost extent of the bale. In many of the most preferred embodiments, the apparatus 10 is not capable of supporting a bale off of the ground surface, but may be usable with a bale feeder 5 which is configured to support the bale off of the ground surface. Thus, in one aspect, the disclosure relates to a combination of the apparatus 10 and a bale feeder 5.

The apparatus 10 may include a perimeter member 12 for positioning about a portion of the bale. The perimeter member 12 may define an opening 14 for at least partially receiving a portion of the bale. The perimeter member 10 may be substantially rigid, and thus may be formed at least partially out from a substantially rigid material so as to maintain its shape under all but the most extreme forces applied to it. The perimeter member may have a perimeter shape which may generally define the shape of the opening, and may be configured to have a size and shape suitable for the particular type of bale for which the apparatus is employed. For example, while the perimeter member may have a round or substantially circular perimeter shape for use with round bales, and may have a rectangular perimeter shape for use with rectangular bales.

The apparatus 10 may also include a web 20 which is mounted on the perimeter member 12 and may extend across the opening 14 of the member 12. The web 20 may have a periphery 22 which is connected to the perimeter member, and in some of the most preferred embodiments the periphery may extend over a larger area than the area that the perimeter member circumscribes when the web 20 is laid flat in a plane. With this size relationship, when the web is positioned on a bale, such as rested on the upper surface 2, the web substantially conforms to the surfaces of the upper portion of the bale and the perimeter member is able to move downwardly from the top of the bale to extend about the bale. In some embodiments, the weight of the perimeter member may be heavy enough to hold the web against the surface of the bale, such as being held against substantially an entirety of the upper surface of the bale and being held adjacent to the side surface of the bale. In some embodiments, the web 20 may be sized such that positioning the web on the upper surface of the bale permits the perimeter member to move down to a level such that at least an upper half of the height of the bale is positioned at a vertical level higher than the perimeter member, and in some embodiments the web may be sized such that at least an upper two-thirds of the height of the bale is positioned at a vertical level higher than the perimeter member.

The web 20 may be formed by at least one interlinked strand 26 which forms a plurality of holes 28, and the web may be formed by a plurality or multiplicity of interlinked strands 26, 27. The strand or strands may be flexible and may be formed of a flexible material or may be constructed of elements linked together in a manner that permits flexibility. The strand or strands may be substantially unstretchable, and may be formed of a substantially unstretchable material or in such a way that the length of the strand may not be increased by the application of an amount of force capable of being applied by a livestock animal. In some embodiments, the strand or strands may be formed by a chain, while in some embodiments the strand or strands may be formed by a cable, but elongate members formed of other materials with suitable characteristics may be employed, even a fiber rope.

The plurality of strands 26, 27 may be connected together to form the plurality of holes between the strands in a reticulated configuration. In some embodiments, the holes may be substantially diamond shaped, and may be formed by alternately connecting a strand to adjacent strands located on opposite sides of the strand to form the diamond-shaped holes. The size of the holes may be substantially uniform inside the periphery 22, but may be somewhat diminished in size and altered in shape along the periphery 22. In some embodiments, the size of the holes formed by the strands may be sized for use for feeding a particular type of livestock. The size of the hole may be configured to permit only a portion of the nose of the livestock to penetrate through the holes to thus contact and penetrate into the bale of feed material positioned beneath the apparatus 10. Thus, the relative size of the hole may change according to the relative size of the nose of the animal with which the apparatus may be used. The size of the holes of the web 20 may function not only to partially restrict the animal's ability to insert its nose and mouth through the web and into the bale of feed material, but may also restrict the animal's ability to pull large chunks off of the bale through the web 20 of the apparatus.

In use, the apparatus may be placed over a bale that is resting on the ground or is supported off of the ground surface by a bale feeder. the web is rested upon the uppermost surfaces of the bale, and may drape over portions of the side surfaces of the bale so that the perimeter member is suspended by the web from the bale, and as the bale is depleted, the apparatus moves downwardly as the surfaces of the bale supporting the web are eaten away by the livestock. The weight of the web and the perimeter member tends to hold the baled feed material together as a unit even as pieces of the bale are removed.

It should be appreciated that in the foregoing description and appended claims, that the terms “substantially” and “approximately,” when used to modify another term, mean “for the most part” or “being largely but not wholly or completely that which is specified” by the modified term.

It should also be appreciated from the foregoing description that, except when mutually exclusive, the features of the various embodiments described herein may be combined with features of other embodiments as desired while remaining within the intended scope of the disclosure.

Further, those skilled in the art will appreciate that the steps shown in the drawing figures may be altered in a variety of ways. For example, the order of the steps may be rearranged, substeps may be performed in parallel, shown steps may be omitted, or other steps may be included, etc.

With respect to the above description then, it is to be realized that the optimum dimensional relationships for the parts of the disclosed embodiments and implementations, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present disclosure.

Therefore, the foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that fall within the scope of the claims.

1.-20. (canceled)

21. An apparatus for controlling consumption of a bale of feed material by livestock, the apparatus comprising:
a perimeter member for positioning about a portion of the bale, the perimeter member being rigid and defining a continuous perimeter with an opening for at least partially receiving a portion of the bale, the perimeter member being circular or rectangular in shape;
a web mounted on the perimeter member and extending across the opening of the perimeter member, the web having a periphery connected to the perimeter member, the web being entirely formed of a plurality of strands with each of the strands being formed entirely of cable, the plurality of cable strands forming a plurality of holes between the cable strands in a reticulated configuration;
wherein each cable strand of said plurality of cable strands is alternately connected to adjacent cable strands on opposite sides of said cable strand to form each of the holes with a diamond shape;
wherein the perimeter size of the holes in the web is uniform;
wherein the cable strands of the plurality of cable strands forming the web are each formed of a flexible material;
wherein the cable strands of the plurality of cable strands forming the web are each formed of an unstretchable material such that flexing of the cable strands does not increase the perimeter size of the holes of the web greater than the uniform perimeter size; and
wherein the area of the web is larger than an area circumscribed by the perimeter member such that, when the web is rested upon a bale, a weight of the perimeter member tensions the web so that the cable strands of the web conform to an upper surface and portions of side surfaces of the bale to form a bell-shaped dome over the bale with an upper portion of the bale fitting into the dome formed by the web and the perimeter member falling down from the top of the bale and extends about the bale.

22. (canceled)
